(19) United States
(12) Patent Application Publication
(10) Pub. No.: US 2022/0179278 A1
(43) Pub. Date: Jun. 9, 2022

(54) METHOD FOR SPATIALLY OR TEMPORALLY SHAPING A LASER BEAM

(71) Applicant: COMMISSARIAT A L'ENERGIE ATOMIQUE ET AUX ENERGIES ALTERNATIVES, Paris (FR)

(72) Inventors: Lionel LACAMPAGNE, Gujan Mestras (FR); Sébastien VERMESCH, La Teste (FR); Pauline FOURTILLAN, Le Barp (FR); Xavier JULIEN, Sanguinet (FR)

(73) Assignee: COMMISSARIAT A L'ENERGIE ATOMIQUE ET AUX ENERGIES ALTERNATIVES, Paris (FR)

(21) Appl. No.: 17/598,027

(22) PCT Filed: Mar. 16, 2020
(86) PCT No.: PCT/FR2020/050568

§ 371 Date: Sep. 24, 2021

(30) Foreign Application Priority Data
Mar. 27, 2019 (FR) 1903192

(51) Int. Cl. G02F 1/21; G01J 1/42; G02F 1/01

(52) U.S. Cl. CPC G02F 1/212; G01J 1/4257; G02F 2201/58; G02F 2203/18; G02F 2203/26; G02F 1/0121

(57) ABSTRACT

The present invention concerns an iterative method for spatially or temporally shaping a laser beam. The spatial shaping of the beam uses a light valve and the temporal shaping of a pulse uses a Mach-Zehnder modulator. At each spatial shaping iteration, the profile of the observed beam is projected onto an adapted basis set in order to obtain observed profile components in this basis set. The ratios are calculated between the components of a setpoint profile in this basis set and the components of the observed profile, and the ratio of the profiles at the output of the light valve is deduced. The control for each element of the valve is then determined as the product of the control for this same element, obtained at the previous iteration, and the ratio of the profiles for the position of this element, obtained at the current iteration.

### TECHNICAL FIELD

The present invention relates to the field of spatial or temporal shaping of a laser beam, in particular of a laser pulse.

### PRIOR ART

The spatial or temporal shaping of a laser beam has many practical applications from microlithography to power amplification and from optical data storage to medical treatment.

Generally, the spatial shaping of a laser beam consists in redistributing the intensity and/or phase profile of the beam in a transverse plane, that is to say orthogonal to the direction of propagation of this beam. Next, we will content with a spatial shaping to comply with a predetermined intensity transverse profile, called setpoint spatial profile. A particular, yet frequent, case of setpoint spatial profile is that of a uniform distribution. For example, this will consist in transforming the Gauss-like shaped profile of a beam into a constant profile, so as to obtain a uniform illumination in the transverse plane.

Different methods for spatially shaping a laser beam are known from the state of the art. For example, it is possible to use an optical element such as a lens to transform a Gauss-like shaped profile into a uniform profile (field mapping) or it is still possible to split the beam into a plurality of elementary beams and use an array of microlenses to homogenise the beam (beam integrating). Nonetheless, these methods have the drawback of not being adaptive to the extent that they are suited only for determined input profile and output profile of a beam.

An adaptive method for spatially shaping a beam has been illustrated in FIG. 1. It consists in illuminating an optical valve such as an array of passive elements to control the transmission of the beam in the transverse plane. Each element of the array could be controlled independently so as to be able to obtain the desired setpoint profile at the output. More specifically, a merit function measuring the difference between the beam profile B(x,y), observed at the output of the optical valve, and the setpoint profile B^{u}(x,y), is generally defined. The shaping then amounts to finding the control C allowing minimising the difference |B(x,y)−B⁰(x,y)∥².

The control C may be represented by a vector c, called control vector, with a size of M, providing the voltages to be applied to the different elements of the optical valve. The observed profile and the setpoint profile may be assimilated to matrices providing the intensities of the beam at different points of a transverse plane, at the output of the optical valve. Each of these matrices may be represented by a column vector, called profile vector, with a size of, P, for example by concatenating the column vectors of the considered matrix, namely b the observed profile vector and b^{u} the setpoint profile vector.

In the same manner as with the techniques used in adaptive optics, it is possible to perform a linear approximation by supposing that the response h linearly depends on the control c. In other words, only the derivatives of the merit function, called influence function, are then considered. The matrix allowing switching from the control vector c into the profile vector h is called interaction matrix, S, and has a size of P×M. It could be determined by successively controlling the different elements of the optical valve and by observing the corresponding profile vector. The profile vectors obtained in this manner are no more than the column vectors of the interaction matrix. The interaction matrix could be decomposed according to an SVD (Singular Value Decomposition) decomposition:

S=UΛV^{T} (1)

where U with a size of P×M and V with a size of M×M are orthogonal matrices and Λ is a matrix with a size of M×M whose diagonal terms are the singular values of the matrix S.

If the matrix Λ has a rank of M, that is to say if the singular values are different from zero, the control c is then determined by:

c=S^{†}b⁰ (2)

where S^{†}=VΛ⁻¹U^{I} is the pseudo-inverse of the matrix S.

In practice, we proceed by successive iterations and at each iteration we measure the intensity transverse profile by applying the control calculated at the previous step.

This spatial shaping method provides a correct result unless the merit function features local minimums (in this case, we should resort to simulated annealing algorithms or genetic algorithms which require a large number of assessments of the merit function).

Furthermore, a major drawback of this spatial shaping method is that it requires a large number of observations. In some cases, in particular when it is necessary to proceed with high-power laser shots, this drawback becomes prohibitive because the shot rate is not compatible with the stability of the system.

To circumvent this difficulty, we then suppose that it is possible to associate to each element of the control one and only one observed pixel (in this case P=M) and that each element of the control has the same effect on the observed pixels, in other words the system is invariant except for a translation in the transverse plane.

In practice, the univocal association of an observed pixel with a control element requires correcting the tilting, the centring and the magnification (that is to say respectively the translational offset, the rotation and the homothety) of the image of the beam in the transverse plane. However, this operation, called planar transformation, considerably weights down the calculations of the control. Furthermore, the association between the control elements and the pixels in the transverse plane is relatively inaccurate, in particular for pixels located on the edges and in the angles of the image. This results in that the algorithm could converge towards values distinct from that of the setpoint for these pixels as illustrated in FIG. 2.

In this figure, we have represented to the left the setpoint profile that we wish to obtain at the output of the optical valve, herein a square-shaped uniform two-dimensional distribution. To the right, we have represented the result obtained at the output of the optical valve by applying the control obtained according to the above-described shaping method, after application of the plane transform. We see that the areas in the corners of the image have defects as they include pixels having intensity levels distinct from the setpoint level.

Similarly, the temporal shaping of a laser beam, and more specifically of a laser pulse, consists in modifying the temporal shape of a pulse so that the latter complies with a predetermined temporal distribution, called setpoint temporal profile.

The article of T. Baumert et al. entitled “Femtosecond pulse shaping by an evolutionary algorithm with feedback” published in Appl. Phys. B 65, pp. 779-782 (1997) proposes a method for temporally shaping a laser pulse from a spatial shaping device, as schematically represented in FIG. 3.

First of all, the femtosecond laser pulse to be temporally shaped is temporally enlarged in a dispersive material, 310. Afterwards, the beam is directed towards a first diffraction grating, 320, separating the different wavelengths. The components with the different wavelengths are focused by a first lens, 330, at different points of a LCD modulator serving as an optical valve, 340, located in its focal plane. The optical valve filters the spectrum of the pulse by means of a transfer function corresponding to the control of the modulator. Afterwards, the different spectral components are recombined by means of a second lens, 350, and a second grating, 360, respectively symmetrical of the first lens and of the first grating with respect to the LCD modulator. Hence, the temporal shaping of the pulse is herein carried out by the LCD modulator in the spectral field, the dispersal introduced by the first grating being compensated by the dispersal introduced by the second grating.

Consequently, it is understood that a temporal shaping of a laser beam could be carried out by means of a spatial shaping by an optical valve placed in the focal plane of a lens. This temporal shaping then suffers from the same limitations as the spatial shaping disclosed hereinabove.

Alternatively, it is possible to modify the temporal profile of a pulse by means of a Mach-Zehnder (MZ) modulator. The intensity of the laser pulse is then modulated by making the control of the electro-optical element of the MZ modulator vary while the pulse crosses it.

Like in the spatial shaping, it is possible to define a merit function as the difference between the intensity temporal profile, as observed at the output of the MZ modulator and the setpoint temporal profile, namely |B(t)−B⁰(t)∥². The acquisition of the intensity over time could be carried out from a mere photodiode.

The control could be obtained like before by calculating the pseudo-inverse matrix of the interaction matrix. To simplify the calculations, it is possible to assume an invariance of the response of the MZ modulator over time. Nonetheless, this supposes that it is possible to associate the control of the modulator to a time point of observation of the intensity of the pulse. This association is one-dimensional and therefore simpler than in the case of the spatial shaping. Nevertheless, this association is still inaccurate on the rising and falling edges of the pulse, and that being so because of the limited bandwidth of the measuring device with regards to the sampling frequency of the control of the MZ modulator.

Thus, it is possible to have a divergence between the observed temporal profile and the setpoint profile as illustrated in FIG. 4. Notice that the temporal profile of the pulse has defects (edge effects) in particular at the beginning and at the end of the pulse.

Generally, whether in the context of a spatial or temporal shaping, the algorithms allowing calculating the control lack robustness on the rising and falling edges of the signals, that is to say in the high-gradient areas of the signal. This might lead to inhomogeneities in the beam (spatial shaping) or to the apparition of holes and peaks in the pulse (temporal shaping).

Consequently, an object of the present invention is to provide a method for spatially or temporally shaping a laser beam which does not have the aforementioned drawbacks, in particular one which does not require complex calculations and which has no edge effects in the high-gradient signal areas.

### DISCLOSURE OF THE INVENTION

The present invention is defined by a method for spatially shaping a laser beam by means of an optical valve including a plurality of pixels controllable in transmission by means of a control vector, each element of the control vector controlling the transmission of a corresponding pixel and being initialised at a predetermined value, the spatial shape of the beam to be obtained being defined by a setpoint profile in a plane transverse to the direction of propagation of the beam, said method including a plurality of successive iterations, the control vector being updated at each iteration, each iteration comprising:
a step of acquiring the image of the beam in said transverse plane at the output of the optical valve, to obtain a profile of the observed beam in this plane;
   a step of calculating the moments of the observed profile with respect to a product base, the product base consisting of products of functions of an adapted base with a square summable over at least one area of the plane containing the support of the setpoint profile, the spectra of said functions according to two axes of the plane being bordered by predetermined maxim um values of spatial frequency;
   a step of calculating the ratios between the components of the setpoint profile and corresponding components of the observed profile in the adapted base, to thereby deduce the ratio between the setpoint profile and the observed profile in the transverse plane;
   a step of determining the control vector at the current iteration according to the ratio calculated at the previous step and the control vector calculated at the previous iteration;
   a step of controlling the optical valve by means of the elements of the control vector determined at the previous step;
   the iterations being carried on until a predetermined stopping criterion is met.

After acquisition of the image of the beam in the transverse plane, said image is advantageously corrected by tilting, centring and magnification before obtaining the observed profile.

Preferably, the adapted base is orthogonal and consists of polynomial or monomial functions.

The polynomial functions may consist of Zernike polynomials.

Alternatively, the monomial functions may be of the type fᵢⱼ(x,y)=xⁱy^{j}, such that i+j≤dₘₐₓ where dₘₐₓ is a predetermined maximum degree and x, y are Cartesian coordinates in the transverse plane.

Advantageously, the area of the plane, Ω, surrounds the support of the setpoint profile, σ, by a predetermined safety margin.

Typically. the calculation of the moments of the observed profile is performed by means of

$${\int \int }_{Ω} {f}_{pq} ( x , y ) {f}_{ij} ( x , y ) B ( x , y ) dxdy$$

where f_{pq}(x,y), fᵢⱼ(x,y) are two functions of the adapted base and B(x,y) is the observed profile in the transverse plane.

The calculation of the ratios between the components of the setpoint profile and corresponding components of the observed profile in the adapted base is performed by \tilde{r}ₙ=\tilde{B}ₙ⁻¹\tilde{b}⁰ where Bₙ represents the matrix of the moments of the observed profile, \tilde{b}⁰ is a vector whose elements provide the projection of the setpoint profile on the different functions of the adapted base and \ddot{r}ₙ is a vector whose elements provide the ratios between the components of the setpoint profile and of the observed profile in the adapted base.

The ratio between the setpoint profile and the observed profile in the transverse Plane is calculated at the current iteration by means of

$${R}_{n} ( x , y ) = {\sum }_{i = 1}^{N} {\sum }_{j = 1}^{N} {\tilde{r}}_{ij , n} {f}_{ij} ( x , y )$$

where fᵢⱼ(x,y) are the functions of the adapted base and \ddot{r}_{ij,n} the ratios between the components of the setpoint profile and of the observed profile at the current iteration in the adapted base and the control vector of the current iteration, cₙ, is deduced as that whose elements are the products of the elements of the control vector at the previous iteration, cₙ₋₁, and the values of the ratio Rₙ(x,y) taken at the points where the transmission-controllable pixels are located.

The stopping criterion is met when the values of the ratio Rₙ(x,y) taken at the points where all of the transmission-controllable pixels are comprised within a tolerance interval around the value 1.

The invention also relates to a method for temporally shaping a laser pulse by means of an intensity modulator, the intensity of the pulse could be controlled over time by a control vector, each element of the control vector controlling the transmission of the modulator at a given time point and being initialised at a predetermined value, the temporal shape to be obtained being defined by a setpoint profile, said method including a plurality of successive iterations, the control vector being updated at each iteration, each iteration comprising:

a step of acquiring the pulse at the output of the modulator to obtain an observed profile of the pulse;
a step of calculating the moments of the observed profile with respect to a product base, the product base consisting of the products of functions of an adapted base with a square summable over at least one time interval containing the support of the setpoint profile, the spectra of said functions being bordered by a predetermined maximum value of frequency;
a step of calculating the ratios between the components of the setpoint profile and corresponding components of the observed profile in the adapted base, to thereby deduce the ratio between the setpoint profile and the observed profile in the transverse plane over the time interval;
a step of determining the control vector at the current iteration according to the ratio calculated at the previous step and the control vector calculated at the previous iteration;
a step of controlling the intensity modulator by means of the elements of the control vector determined at the previous step;
the iterations being carried on until a predetermined stopping criterion is met.

In particular, the intensity modulator may consist of a Mach-Zehnder modulator.

In particular, the acquisition of the pulse may be carried out by means of a photodiode at the output of the intensity modulator and by a storage oscilloscope.

Preferably, the adapted base is orthogonal and consists of polynomial or monomial functions. The polynomial functions may consist of Legendre polynomials.

Advantageously, the time interval, Ω, includes the support of the setpoint profile, σ, with a predetermined safety margin.

Typically, the calculation of the moments of the observed profile of the pulse is performed by means of

$${\int }_{Ω} {f}_{i} ( t ) {f}_{j} ( t ) B ( t ) dt$$

where fᵢ(t), fⱼ(t) are two functions of the adapted base and B(t) is the observed profile of the pulse.

The calculation of the ratios between the components of the setpoint profile and corresponding components of the observed profile in the adapted base is performed by \tilde{r}ₙ=\tilde{B}ₙ⁻¹\tilde{b}⁰ where \tilde{B}ₙ represents the matrix of the moments of the observed profile, \ddot{b}^{u} is a vector whose elements provide the projection of the setpoint profile on the different functions of the adapted base and \tilde{r}ₙ is a vector whose elements provide the ratios between the components of the setpoint profile and of the observed profile in the adapted base.

The ratio between the setpoint profile and the observed profile in the time interval is calculated by means of

$${R}_{n} ( t ) = {\sum }_{i = 1}^{N} {\tilde{r}}_{n , j} {f}_{i} ( t )$$

where \ddot{r}_{n,i} is the i^{th} component of \ddot{r}ₙ where fᵢ(t) are the functions of the adapted base and \ddot{r}_{n,i} the ratios between the components of the setpoint profile and of the observed profile at the current iteration in the adapted base and the control vector of the current iteration, cₙ, is deduced as that whose elements are the products of the elements of the control vector at the previous iteration, cₙ₋₁, and the values of the ratio Rₙ(t) taken at the time points at which the transmission of the intensity modulator is controlled.

The stopping criterion is met when all of the values of the ratio Rₙ(t) taken at the time points at which the transmission of the intensity modulator is controlled, are comprised within a tolerance interval around the value 1.

### BRIEF DESCRIPTION OF THE FIGURES

Other features and advantages of the invention will appear upon reading a preferred embodiment of the invention, described with reference to the appended figures among which:

FIG. 1 schematically represents a device for spatially shaping a laser beam, known from the state of the art;

FIG. 2 shows, on an example, the edge effects occurring in the spatial shaping of a laser beam by means of the device of FIG. 1;

FIG. 3 schematically represents a first device for temporally shaping a laser beam, known from the state of the art;

FIG. 4 schematically illustrates a second device for temporally shaping a laser beam, known from the state of the art;

FIG. 5 shows, on an example, edge effects occurring in the temporal shaping by means of the device of FIG. 4;

FIG. 6 represents, in the form of a flowchart, a method for spatially shaping a laser beam according to a first embodiment of the invention;

FIG. 7 represents a comparative example of a spatial shaping of a laser beam according to the first embodiment of the invention and according to a known method of the state of the art;

FIG. 8 represents, in the form of a flowchart, a method for temporally shaping a laser beam according to a second embodiment of the invention;

FIG. 9 represents a comparative example of a temporal shaping of a laser beam according to the second embodiment of the invention and a method known from the prior art.

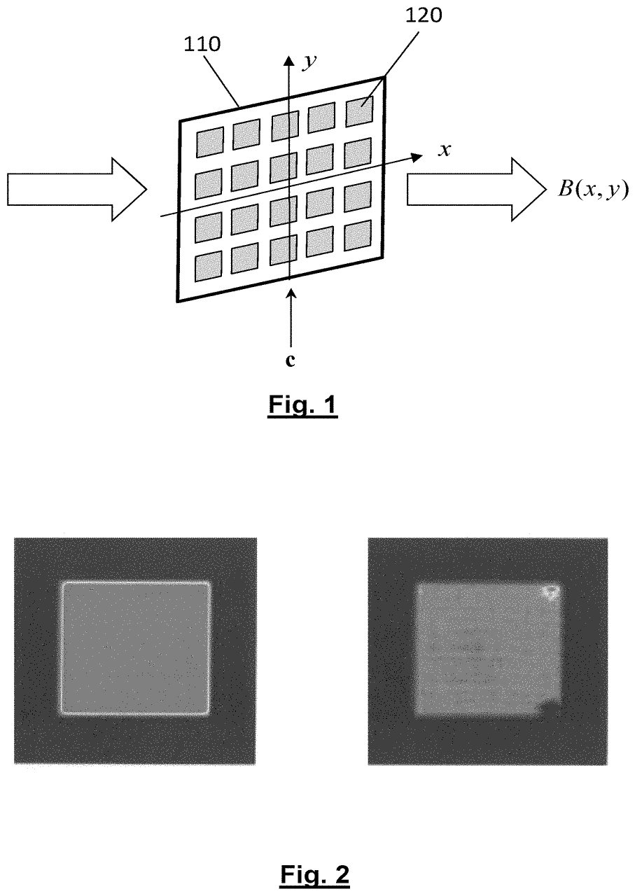

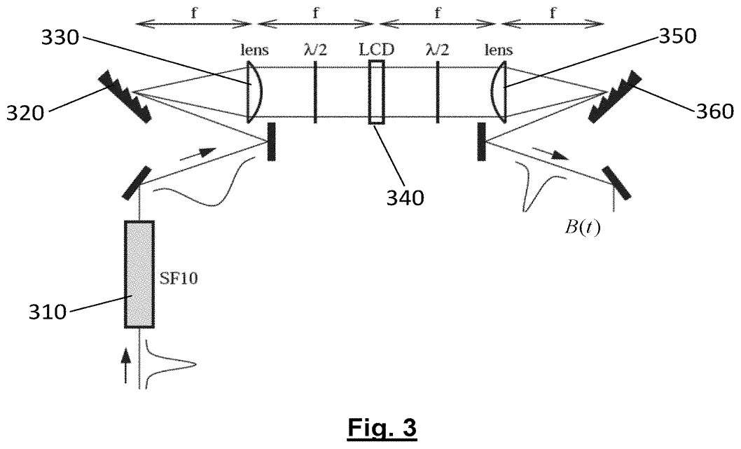

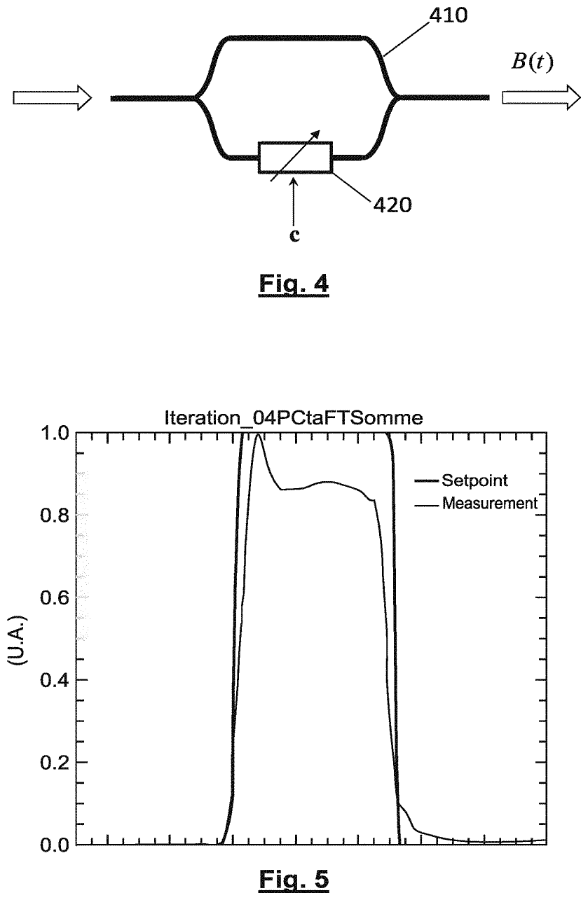

### DESCRIPTION OF THE EMBODIMENTS

First of all, a device for spatially shaping a laser beam as represented in FIG. 1 will be considered.

The idea at the origin of the invention consists in getting rid of the edge effects by using the method of moments in the calculation of the control.

Like before, the intensity profile of the beam, as observed, in a transverse plane at the output of the optical valve is denoted B(x,y), and the setpoint profile is denoted B⁰(x,y).

We seek to compare the profiles B(x,y) and B⁰(x,y).

For this purpose, we define

$$R ( x , y ) = \frac{{B}^{0} ( x , y )}{B ( x , y )}$$

providing the ratio between the observed profile and the setpoint profile. An obvious method would consist in calculating this ratio at each point. Nonetheless, it is clear that such a method cannot be applied in the areas where B(x,y) is low or zero as this might be the case at the beam edge since the correction of the image of the beam in the transverse plane (tilting, centring and magnification) is not perfect. This difficulty could be circumvented by performing the calculation of R(x,y) only in the areas where B(x,y) is higher than a predetermined threshold value and by extrapolating the result in the high-gradient areas, at the beam edge. Nonetheless, this method supposes having a good prior knowledge of the profile of the beam and is not robust at all.

To overcome the poor conditioning of the ratio R(x,y) at the beam edge, it is proposed to express it in a weak form:

∫∫F(x,y)R(x,y)B(x,y)dxdy=∫∫F(x,y)B⁰(x,y)dxdy (3)

where P(x,y) is any signal in the transverse plane. It should be noticed that the summation in the right-side term is performed on the support σ of the setpoint profile while the summation in the left-side term could cover a wider area than σ.

A necessary and sufficient condition for the relationship (3) to be met ∀F, is that it is met for functions forming a base of L²( [symbol] ²), that is to say of the space of the functions whose square can be integrated over L²(Ω) where Ω includes the support σ with a safety margin. For example, if σ=└−α,α┘×└−α,α┘, it is possible to consider Ω−└−α−ε,α+ε┘×└−α−ε,α×ε┘ where ε is the safety margin.

In practice, we will just consider a free family, Λ(Ω), with N² functions of L²(Ω) whose spectra according to the axes Ox and Oy are bordered by predetermined maximum values of spatial frequency. Λ(Ω) will somewhat imprecisely be referred to as base of L²(Ω).

The predetermined maximum values of spatial frequency are determined by the desired spatial resolution according to the axes Ox and Oy, that is to say by

$$\frac{1}{{δ}_{x}} , \frac{1}{{δ}_{y}}$$

where δₓ,δ_{y} are discretisation intervals according to these axes. Advantageously, we will choose δₓ (resp. δ_{y}) equal to the lowest value amongst the sampling step of the setpoint profile, the sampling step of the measured profile at the output of the optical valve and the step of the pixels of the optical valve, in other words the application step of the control, according to the axis Ox (resp. Oy).

Consider fᵢⱼ, i=1, . . . , N, j=1, . . . , N the elements of the base Λ(Ω), tₕₑ relationship (3) becomes if we content with a N-order development of R(x,y) in this base:

$$\int \int {f}_{pq} ( x , y ) {\sum }_{i = 1}^{N} {\sum }_{j = 1}^{N} {\tilde{r}}_{ij} {f}_{ij} ( x , y ) B ( x , y ) d x d y = \int \int {f}_{pq} ( x , y ) {B}^{0} ( x , y ) d x d y \\ ∀ p , q , 1 \leq p \leq N , 1 \leq q \leq N . \qquad ( 4 )$$

The relationship (4) could also be exoressed in an equivalent manner by:

$${\sum }_{i = 1}^{N} {\sum }_{j = 1}^{N} {\tilde{r}}_{ij} ( \int \int {f}_{pq} ( x , y ) {f}_{ij} ( x , y ) B ( x , y ) d x d y ) = \int \int {f}_{pq} ( x , y ) {B}^{0} ( x , y ) d x d y \qquad ( 5 )$$

or in a still more condensed manner in matrix form:

\tilde{B}\tilde{r}=\tilde{b}⁰ (6)

where \tilde{b}⁰ is the vector with a size of N² consisting of the concatenation of the column vectors of the matrix \ddot{B}^{u} whose elements are given by \ddot{b}_{pq}⁰=∫∫f_{pq}(x,y)B⁰(x,y)dxdy, \ddot{B} is the matrix with a size of N²×N² whose elements are given by \tilde{b}_{Ri}=(∫∫f_{pq}(x,y)fᵢⱼ(x,y)B(x,y)dxdy) with c=(q−1)N+p, l=(j−1)N+i and \tilde{r} is the vector with a size of N² resulting from the concatenation of the column vectors of the matrix \ddot{R} whose elements are given by \tilde{R}ᵢⱼ=\tilde{r}ᵢⱼ;

The base fᵢⱼ of L²(Ω) is chosen orthogonal and adapted to the geometry of the beam. Preferably, the base is chosen polynomial or monomial. For example, for a beam with a rectangular section, it is possible to select the monomial functions fᵢⱼ(x,y)=xⁱy^{j} (assuming the coordinates x,y normalised by the dimensions of Ω according to the axes Ox and Oy) and content with those meeting i+j<dₘₐₓ where dₘₐₓ is a maximum degree or with those such that i+j=d where d is the degree of the considered monomials.

It should be understood that when the beam features an axis symmetry, a polar base will be chosen rather than a Cartesian base. The relationship (5) will then be advantageously expressed in polar coordinates:

$${\sum }_{i = 1}^{N} {\sum }_{j = 1}^{N} {\tilde{r}}_{ij} ( \int \int {f}_{pq} ( r , θ ) {f}_{ij} ( r , θ ) B ( r , θ ) r d r d θ ) = \int \int {f}_{pq} ( r , θ ) {B}^{0} ( r , θ ) r d r d θ \qquad ( 7 )$$

An adapted base may then be that of Zernike or pseudo-Zernike polynomials.

In any case, it is possible to obtain the vector \tilde{r} of the ratio of the profiles by means of:

\tilde{r}=\tilde{B}⁻¹\tilde{b}⁰ (8)

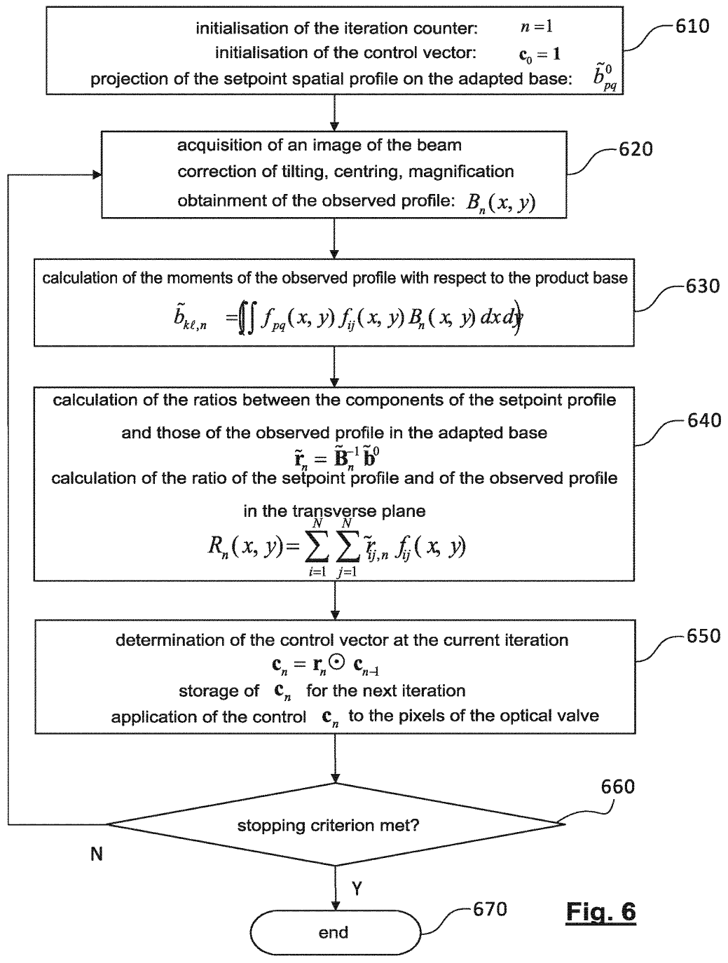

FIG. 6 represents in the form of a flowchart a method for spatially shaping a laser beam according to a first embodiment of the invention.

For this method, the device already illustrated in FIG. 1 is used, the optical valve being illuminated by the beam to be spatially shaped.

Suppose we wish to obtain a setpoint profile (B^{u}(x,y), B^{u}(r,θ)) at the output of the optical valve.

At step 610, an iteration counter is initialised: n=1.

The setpoint profile is further projected on the functions of the adapted base to obtain the coefficients \ddot{b}_{pq}⁰ for the first N functions of the base.

The control of the different elements (or pixels) of the optical valve is also initialised at a predetermined value, for example c₀=⊥ where ⊥ is the vector with a size of M all elements of which are equal to 1. The size lid depends on the discretisation step of the control and on the dimensions of the beam.

Afterwards, we get into an iterative loop wherein the control to be applied to the elements is progressively built so as to obtain the setpoint profile.

In 620, the acquisition of an image of the beam in a transverse plane at the output of the optical valve is performed. Optionally yet advantageously, a planar transformation is performed to correct the tilting, centring and magnification of the image obtained at the previous step. In any case, a profile of the observed beam is obtained (Bₙ(x,y), Bₙ(r,θ)).

At step 630, the moments of the observed profile are calculated with respect to the product base. The product base is defined as all of the products of the functions of the adapted base.

In other words, in a representation in Cartesian coordinates, the elements \tilde{b}_{Ri,n}=(∫∫f_{pq}(x,y)fᵢⱼ(x,y)Bₙ(x,y)dxdy) are calculated as defined before. Thus, a matrix \tilde{B}ₙ is formed from these elements, where \tilde{b}_{Ri,n} is the element at the row c and the column l of \tilde{B}ₙ.

At step 640, the vector of the ratios of the components of the profiles in the adapted base, \ddot{r}ₙ, is calculated by means \tilde{r}ₙ=\ddot{B}ₙ⁻¹b̅^{u} and then the ratio of the profiles in the transverse plane is thereby deduced by means of

$${R}_{n} ( x , y ) = {\sum }_{i = 1}^{N} {\sum }_{j = 1}^{N} {\tilde{r}}_{ij , n} {f}_{ij} ( x , y )$$

wherein \tilde{r}_{ij,n} is the (j−1)N+i-th component of \ddot{r}ₙ. In practice, Rₙ(x,y) is discretised (spatially sampled) at the same points as the control cₙ₋₁, to obtain a vector rₙ with a size of M. The control to be applied is then defined by the vector:

cₙ=rₙ⊙cₙ₋₁ (9)

where ⊙ is Hadamard product. The new control vector is stored for the next iteration.

At step 650, the control determined at the previous step, cₙ, is applied to the different pixels of the optical valve. More specifically, each element of cₙ is applied to a corresponding transmission-controllable pixel of the optical valve.

At step 660, we test whether a stopping criterion is met. If this is not the case, we return back to step 620. Conversely, if so, the spatial shaping method terminates at 670. The stopping criterion may consist of a condition on the elements of the vector rₙ, namely that all of them are comprised within a tolerance interval around the value 1 or, failing that, that a predetermined maximum number of iterations nₘₐₓ is reached.

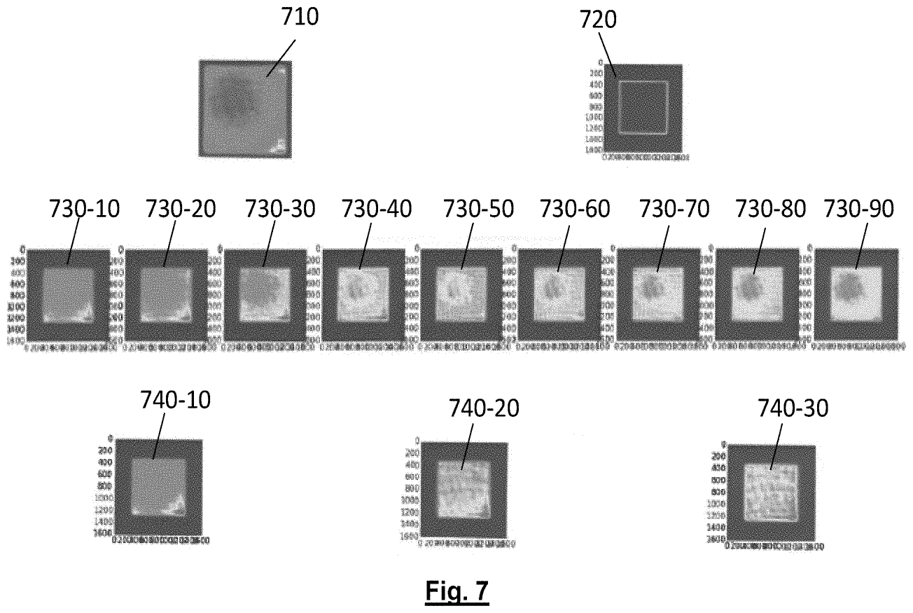

FIG. 7 represents a comparative example of a spatial shaping of a laser beam according to the first embodiment of the invention and according to a known method of the state of the art.

We have indicated in 710, the profile of the beam at the output of the optical valve in the absence of control (c₀=⊥) and in 720, the setpoint profile, chosen to be uniform in this instance.

The profiles indicated by 730-1 to 730-9 correspond to the first 9 iterations of the spatial shaping method known from the state of the art, as disclosed in connection with the expressions (1) and (2), in other words by the iterated calculation of the pseudo-inverse of the interaction matrix. Within 9 iterations, we notice the formation of a hole at the middle of the profile. The profiles indicated by 740-1 to 740-3 correspond to the first 3 iterations of the spatial shaping method according to the first embodiment of the invention, as disclosed in connection with FIG. 6.

In this instance, the adapted base was that of 5-degree monomials, that is to say fᵢⱼ(x,y)=xⁱy^{j} with i+j=5. Within 3 iterations, we notice that the profile is much more uniform than that obtained by the known method of the state of the art after 9 iterations.

We now consider the device for temporally shaping a laser beam, such as that represented in FIG. 4.

Like the spatial shaping, the method for temporally shaping the beam gets rid of the edge effects by using the method of moments.

More specifically, the temporal profile of the laser pulse at the output of the MZ modulator is denoted B(t) and the setpoint temporal profile is denoted B^{u}(t).

We compare the profiles B(t) and B^{u}(t) by means of the ratio

$$R ( t ) = \frac{{B}^{U} ( t )}{B ( t )} .$$

To overcome the poor conditioning of the ratio R(t) at the beginning and at the end of the pulse, it is proposed, like before, to express it in a weak form:

∫F(t)R(t)B(t)dt=∫F(t)B⁰(t)dt (10)

where P(t) is any temporal signal. The summation in the right-side term is performed on the support c) of the setpoint temporal profile while the summation in the left-side term could cover a wider area than σ.

A necessary and sufficient condition for the relationship (10) to be met ∀F, is that it is met for functions forming a base of L²( [symbol] ), still more simply of L²(Ω) where Ω includes the support σ with a safety margin. For example, if σ=[tₛₜₐᵣₜ,t_{end}], it is possible to take Ω[tₛₜₐᵣₜ−ε,t_{end}+ε] where ε is the safety margin.

In the same manner as before, in practice, we will consider a free family, Λ(Ω), of N functions of L²(Ω) whose spectra are bordered by a predetermined maximum value of frequency. Λ(Ω) will somewhat imprecisely be referred to as base of L²(Ω).

The predetermined maximum value of frequency is determined by the desired temporal resolution,

$$\frac{1}{{δ}_{t}} .$$

Advantageously, we will choose 67 ₜ equal to the lowest value amongst the sampling period of the setpoint temporal profile, the sampling period of the temporal profile measured at the output of the optical valve and the period of application of the temporal control in the modulator MZ.

Consider fᵢ, i=1, . . . , N the elements of Λ(Ω), the relationship (10) becomes if we content with a N-order development of R(t) in this base:

$$\int {f}_{j} ( t ) {\sum }_{i = 1}^{N} {\tilde{r}}_{i} {f}_{i} ( t ) B ( t ) d t = \int {f}_{j} ( t ) {B}^{0} ( t ) d t ∀ j , 1 \leq j \leq N \qquad ( 11 )$$

consider also:

$${\sum }_{i = 1}^{N} {\tilde{r}}_{i} \int {f}_{j} ( t ) {f}_{i} ( t ) B ( t ) d t = \int {f}_{j} ( t ) {B}^{0} ( t ) d t \qquad ( 12 )$$

or in a still more condensed manner in matrix form:

\tilde{B}\tilde{r}=\tilde{b}⁰ (13)

where \tilde{b}⁰ is the vector with a size of N consisting of the elements \tilde{b}ⱼ⁰=∫fⱼ(t)B⁰(t)dt, j=1, . . . N; \tilde{B} is the symmetrical matrix with a size of N×N whose elements are given by \tilde{b}ᵢⱼ=(∫fᵢ(t)fⱼ(t)B(t)dt) and \ddot{r} is the vector with a size of N whose elements are the components \tilde{r}ᵢ.

The base is chosen orthogonal, preferably polynomial or monomial. For example, it is possible to choose Legendre polynomials as the base.

Finally, it is possible to obtain the vector r of the ratios of the components of the profiles in the adapted base by means of:

\tilde{r}=\tilde{B}⁻¹\tilde{b}⁰ (14)

and to thereby deduce the ratio of the profiles by means of:

$$R ( t ) = {\sum }_{i = 1}^{N} {\tilde{r}}_{i} {f}_{i} ( t ) \qquad ( 15 )$$

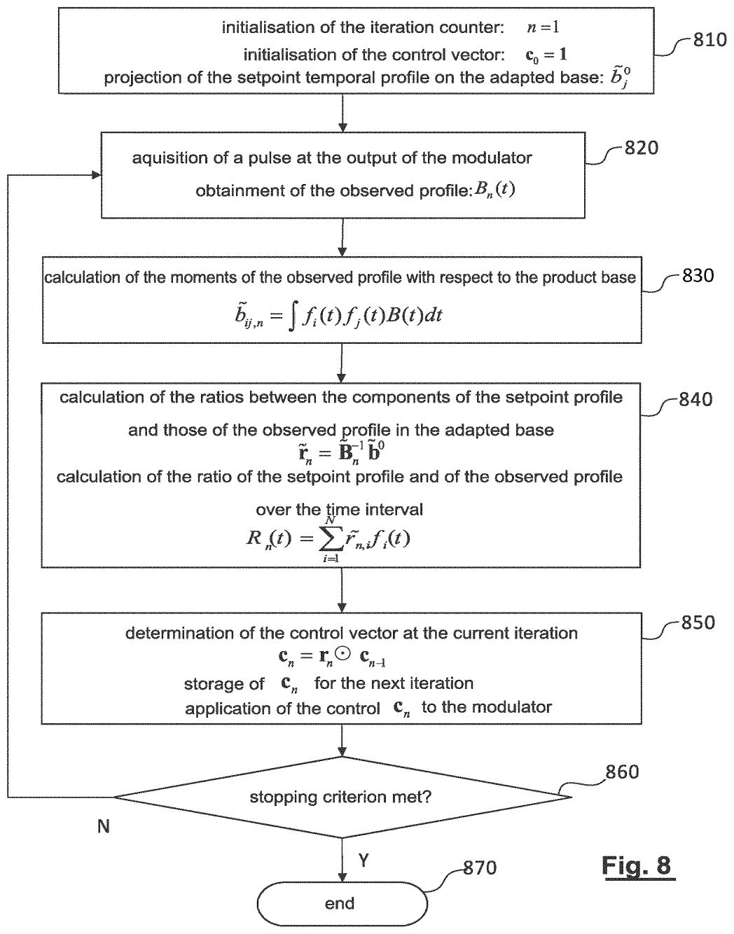

FIG. 8 represents in the form of a flowchart a method for temporally shaping a laser beam according to a second embodiment of the invention.

For this method, the device already illustrated in FIG. 4 is used, the laser beam being injected into the modulator MZ.

Suppose we wish to obtain a setpoint profile B⁰(t) at the output of the intensity modulator.

At step 810, an iteration counter is initialised: n=1.

The setpoint temporal profile is further projected on the functions of the adapted base to obtain the coefficients \tilde{b}ⱼ⁰=∫fⱼ(t)B⁰(t)dt for the first N functions of the base.

The control of the modulator is also initialised, for example c₀=⊥ where ⊥ is the vector with a size of M all elements of which are equal to 1. The size M depends on the sampling period and on the duration of the pulse to be processed (duration of Ω for example).

Afterwards, we get into an iterative loop wherein the control to be applied to the modulator is progressively built so as to obtain the setpoint profile.

In 820, the acquisition of the pulse at the output of the modulator is performed, for example by means of a photodiode or a storage oscilloscope. Thus, a profile of the pulse, observed at the iteration n, is obtained, namely Bₙ(t).

At step 830, the moments of the observed profile are calculated, with respect to functions of the adapted base. In other words, the elements b̅ᵢⱼ=∫fᵢ(t)fⱼ(t)B(t)dt are calculated as defined before. Thus, a matrix \ddot{B}ₙ is built from these elements, where \ddot{b}_{ij,n} is the element at the row z and the column J of \tilde{B}ₙ.

At step 840, the vector of the ratios of the components of the profiles in the adapted base, \ddot{r}ₙ, is calculated by means of \tilde{r}ₙ=\tilde{B}ₙ⁻¹\tilde{b}⁰ and the ratio of the profiles over time is thereby deduced by:

$${R}_{n} ( t ) = {\sum }_{i = 1}^{N} {\tilde{r}}_{n , i} {f}_{i} ( t ) \qquad ( 16 )$$

where \ddot{r}_{n,i} is the i-th component of \ddot{r}ₙ.

At step 850, the control to be applied is calculated by Cₙ(t)=Rₙ(t)·Cₙ₋₁(t). In practice, R(t) (at the same time points at which the control Cₙ₋₁ has been sampled) is sampled so as to obtain a vector cₙ with a size of M. The control to be applied is then defined by the vector:

cₙ=rₙ⊙cₙ₋₁ (17)

where ⊙ is Hadamard product. The application of the control is carried out by modulating the intensity of the pulse over the m-th sampling period by the m-th element of the vector cₙ. The vector cₙ is stored in memory for the next iteration.

At step 860, we test whether a stopping criterion is met. If this is not the case, we return back to step 820. Conversely, if so, the temporal shaping method terminates at 870. The stopping criterion may consist of a condition on the elements of the vector rₙ, namely that all of them are comprised within a tolerance interval around the value 1 or, failing that, that a predetermined maximum number of iterations nₘₐₓ is reached.

1. A method for spatially shaping a laser beam by an optical valve including a plurality of pixels controllable in transmission by a control vector, each element of the control vector controlling the transmission of a corresponding pixel and being initialized at a predetermined value, the spatial shape of the beam to be obtained being defined by a setpoint profile in a plane transverse to the direction of propagation of the beam, said method including a plurality of successive iterations, the control vector being updated at each iteration, each iteration comprising:
acquiring the image of the beam in said transverse plane at the output of the optical valve, to obtain a profile of the observed beam in the transverse plane;
calculating the moments of the observed profile with respect to a product base, the product base consisting of products of functions of an adapted base with a square summable over at least one area of the plane containing the support of the setpoint profile, the spectra of said functions according to two axes of the plane being bordered by predetermined maximum values of spatial frequency;
calculating the ratios between the components of the setpoint profile and corresponding components of the observed profile in the adapted base, to thereby deduce the ratio between the setpoint profile and the observed profile in the transverse plane;
determining the control vector at the current iteration according to the ratio calculated at the previous step and the control vector calculated at the previous iteration;
controlling the optical valve by the elements of the control vector determined at the previous step,
wherein the iterations are performed until a predetermined stopping criterion is met.

2. The method for spatially shaping a laser beam according to claim 1, wherein after acquisition of the image of the beam in the transverse plane, said image is corrected by tilting, centering, and magnification before obtaining the observed profile.

3. The method for spatially shaping a laser beam according to claim 1, wherein the adapted base is orthogonal and consists of polynomial or monomial functions.

4. The method for spatially shaping a laser beam according to claim 3, wherein the polynomial functions are Zernike polynomials.

5. The method for spatially shaping a laser beam according to claim 3, wherein the monomial functions are of the type fᵢⱼ(x,y)=xⁱyⁱ, such that i+j≤dₘₐₓ where dₘₐₓ is a predetermined maximum degree and x, y are Cartesian coordinates in the transverse plane.

6. The method for spatially shaping a laser beam according to claim 1, wherein the area of the plane, Ω, surrounds the support of the setpoint profile, σ, by a predetermined safety margin.

7. The method for spatially shaping a laser beam according to claim 6, wherein the calculation of the moments of the observed profile is performed by
$${\int \int }_{Ω} {f}_{p q} ( x , y ) {f}_{ij} ( x , y ) B ( x , y ) d x d y$$
where f_{pq}(x,y), fᵢⱼ(x,y) are two functions of the adapted base and B(x,y) is the observed profile in the transverse plane.

8. The method for spatially shaping a laser beam according to claim 7, wherein the calculation of the ratios between the components of the setpoint profile and corresponding components of the observed profile in the adapted base is performed by \tilde{r}ₙ=\tilde{B}ₙ⁻¹\tilde{b}⁰ where \tilde{B}ₙ represents the matrix of the moments of the observed profile, \tilde{b}⁰ is a vector whose elements provide the projection of the setpoint profile on the different functions of the adapted base and \tilde{r}ₙ is a vector whose elements provide the ratios between the components of the setpoint profile and of the observed profile in the adapted base.

9. The method for spatially shaping a laser beam according to claim 8, wherein the ratio between the setpoint profile and the observed profile in the transverse plane is calculated at the current iteration by
$${R}_{n} ( x , y ) = {\sum }_{i = 1}^{N} {\sum }_{j = 1}^{N} {\tilde{r}}_{ij , n} {f}_{ij} ( x , y )$$
where fᵢⱼ(x,y) are the functions of the adapted base and \tilde{r}_{ij,n} the ratios between the components of the setpoint profile and of the observed profile at the current iteration in the adapted base and the control vector of the current iteration, cₙ, is deduced as that whose elements are the products of the elements of the control vector at the previous iteration, cₙ₋₁, and the values of the ratio Rₙ(x, y) taken at the points where the transmission-controllable pixels are located.

10. The method for spatially shaping a laser beam according to claim 9, wherein the stopping criterion is met when the values of the ratio Rₙ(x, y) taken at the points where all of the transmission-controllable pixels are comprised within a tolerance interval around the value 1.

11. A method for temporally shaping a laser pulse by an intensity modulator, the intensity of the pulse could be controlled over time by a control vector, each element of the control vector controlling the transmission of the modulator at a given time point and being initialized at a predetermined value, the temporal shape to be obtained being defined by a setpoint profile, said method including a plurality of successive iterations, the control vector being updated at each iteration, each iteration comprising:
acquiring the pulse at the output of the modulator to obtain an observed profile of the pulse;
calculating the moments of the observed profile with respect to a product base, the product base consisting of the products of functions of an adapted base with a square summable over at least one time interval containing the support of the setpoint profile, the spectra of said functions being bordered by a predetermined maximum value of frequency;
calculating the ratios between the components of the setpoint profile and corresponding components of the observed profile in the adapted base, to thereby deduce the ratio between the setpoint profile and the observed profile in the transverse plane over the time interval;
determining the control vector at the current iteration according to the ratio calculated at the previous step and the control vector calculated at the previous iteration; and
controlling the intensity modulator by the elements of the control vector determined at the previous step,
wherein the iterations are performed until a predetermined stopping criterion is met.

12. The method for temporally shaping a laser pulse according to claim 11, wherein the intensity modulator is a Mach-Zehnder modulator.

13. The method for temporally shaping a laser pulse according to claim 11, wherein the acquisition of the pulse is carried out by a photodiode at the output of the intensity modulator and by a storage oscilloscope.

14. The method for temporally shaping a laser pulse according to claim 11, wherein the adapted base is orthogonal and consists of polynomial or monomial functions.

15. The method for temporally shaping a laser pulse according to claim 14, wherein the polynomial functions are Legendre polynomials.

16. The method for temporally shaping a laser pulse according to claim 11, wherein the time interval, Ω, includes the support of the setpoint profile, σ, with a predetermined safety margin.

17. The method for temporally shaping a laser pulse according to claim 11, wherein the calculation of the moments of the observed profile of the pulse is performed by
$${\int }_{Ω} {f}_{i} ( t ) {f}_{j} ( t ) B ( t ) d t$$
where fᵢ(t), fⱼ(t) are two functions of the adapted base and B(t) is the observed profile of the pulse.

18. The method for temporally shaping a laser pulse according to claim 17, wherein the calculation of the ratios between the components of the setpoint profile and corresponding components of the observed profile in the adapted base is performed by \tilde{r}ₙ=\tilde{B}ₙ⁻¹\tilde{b}⁰ where \tilde{B}ₙ represents the matrix of the moments of the observed profile, \tilde{b}⁰ is a vector whose elements provide the projection of the setpoint profile on the different functions of the adapted base and \tilde{r}ₙ is a vector whose elements provide the ratios between the components of the setpoint profile and of the observed profile in the adapted base.

19. The method for temporally shaping a laser pulse according to claim 18, wherein the ratio between the setpoint profile and the observed profile in the time interval is calculated by
$${R}_{n} ( t ) = {\sum }_{i = 1}^{N} {\tilde{r}}_{n , i} {f}_{i} ( t )$$
where \tilde{r}_{n,i} is the i^{th} component of rₙ where fᵢ(t) are the functions of the adapted base and \tilde{r}_{n,i} the ratios between the components of the setpoint profile and of the observed profile at the current iteration in the adapted base and the control vector of the current iteration, cₙ, is deduced as that whose elements are the products of the elements of the control vector at the previous iteration, cₙ₋₁, and the values of the ratio Rₙ(t) taken at the time points at which the transmission of the intensity modulator is controlled.

20. The method for temporally shaping a laser pulse according to claim 19, wherein the stopping criterion is met when all of the values of the ratio Rₙ(t) taken at the time points at which the transmission of the intensity modulator is controlled, are comprised within a tolerance interval around the value 1.
